(19) United States
(12) Patent Application Publication
(10) Pub. No.: US 2023/0141014 A1
(43) Pub. Date: May 11, 2023

(54) SYSTEM AND METHOD FOR DISTRIBUTION OF DIGITAL CURRENCY USING A CENTRALIZED SYSTEM

(71) Applicant: PAYCASA INC., Toronto (CA)

(72) Inventor: Mark ITWARU, Toronto (CA)

(21) Appl. No.: 17/971,237

(22) Filed: Oct. 21, 2022

Related U.S. Application Data
(60) Provisional application No. 63/270,271, filed on Oct. 21, 2021.

(51) Int. Cl. G06Q 20/06; G06Q 20/38

(52) U.S. Cl. CPC G06Q 20/0655; G06Q 20/389

(57) ABSTRACT

A system and method for generating encrypted digital currency comprising: a computer processor for executing a set of instructions stored on a computer readable medium to; generate a plurality of unique serial IDs and corresponding currency denominations for the digital currency, each of the currency denominations associated with at least one of the plurality of unique serial IDs; store the plurality of unique serial IDs and corresponding currency denominations in a centralized list; access the list and generate the encrypted digital values using each associated pair of the plurality of unique serial IDs and corresponding currency denominations for the digital currency, each of the encrypted digital values representing the encrypted digital currency; and send one or more of the encrypted digital values to an institution over a communications network for storage in a financial account as an account deposit of the one or more of the encrypted digital values.

### CROSS-REFERENCE TO RELATED APPLICATION

This application claims priority from the benefit of the filing date of U.S. Provisional Patent Application no. 63/270,271 filed on Oct. 21, 2021, entitled “SYSTEM AND METHOD FOR DISTRIBUTION OF DIGITAL CURRENCY USING A CENTRALIZED SYSTEM”, the contents of which are herein incorporated by reference

### FIELD OF INVENTION

The present invention relates generally to the generation and distribution of digital currency.

### BACKGROUND

Typically, countries mandate the printing of money and the national mint creates validated serial numbers for the issued units of currency. However, printed/coined currency has a number of disadvantages, as there is limited ability of a government to track physical currency throughout an economy, which can present several serious threats to sovereign nations. These threats can include issues such as but not limited to: inability to automatically detect and confiscate compromised currency (i.e. counterfeited), inability to easily confiscate existing physical currency which held or otherwise used by nefarious individuals/organizations; increasing cost of printing money, as physical money requires physical minting; possible counterfeiting as physical money security measures (e.g. watermarks, etc.) continue to be overcome by improved counterfeiting methods; tax evasion as money and transactions cannot always be tracked to an individual person/organization; inefficiencies in the collection of taxes at point of purchase; money laundering; increasing costs of international money remittance and international payments as the physical currency requires intermediary US or foreign banks to facilitate the international movement of money; and difficulties in auditable physical currency transfers for both local and international transactions.

Accordingly, it is an object of the present invention to provide a system for generating and distributing digital currency that obviates or mitigates at least some of the problems described above.

### SUMMARY

Printed/coined currency has a number of disadvantages, as there is limited ability of a government to track physical currency throughout an economy, which can present several serious threats to sovereign nations including difficulties in auditable physical currency transfers for both local and international transactions.

In accordance with an aspect of the present invention there is provided a method for generating encrypted digital currency using a computer processor for executing a set of instructions stored on a computer readable medium to; generate a plurality of unique serial IDs and corresponding currency denominations for the digital currency, each of the currency denominations associated with at least one of the plurality of unique serial IDs; store the plurality of unique serial IDs and corresponding currency denominations in a centralized list; access the list and generate the encrypted digital values using each associated pair of the plurality of unique serial IDs and corresponding currency denominations for the digital currency, each of the encrypted digital values representing the encrypted digital currency; and send one or more of the encrypted digital values to an institution over a communications network for storage in a financial account as an account deposit of the one or more of the encrypted digital values.

In accordance with an aspect of the present invention there is provided a system for generating encrypted digital currency comprising: a computer processor for executing a set of instructions stored on a computer readable medium to; generate a plurality of unique serial IDs and corresponding currency denominations for the digital currency, each of the currency denominations associated with at least one of the plurality of unique serial IDs; store the plurality of unique serial IDs and corresponding currency denominations in a centralized list; access the list and generate the encrypted digital values using each associated pair of the plurality of unique serial IDs and corresponding currency denominations for the digital currency, each of the encrypted digital values representing the encrypted digital currency; and send one or more of the encrypted digital values to an institution over a communications network for storage in a financial account as an account deposit of the one or more of the encrypted digital values.

### BRIEF DESCRIPTION OF THE DRAWINGS

Embodiments of the present invention will now be described by way of example only with reference to the following drawings in which:

FIG. 1 is block diagram of a digital currency system infrastructure including a number of networked components;

FIG. 2 is an example of a generated digital currency using the system of FIG. 1;

FIG. 3 is an example transaction implemented for the digital currency of FIG. 2;

FIG. 4 is an example flowchart for the generation and distribution of the digital currency provided by the system of FIG. 1; and

FIG. 5 is an example computer system to implement any one or more of the network components of FIG. 1.

### DETAILED DESCRIPTION OF THE PREFERRED EMBODIMENTS

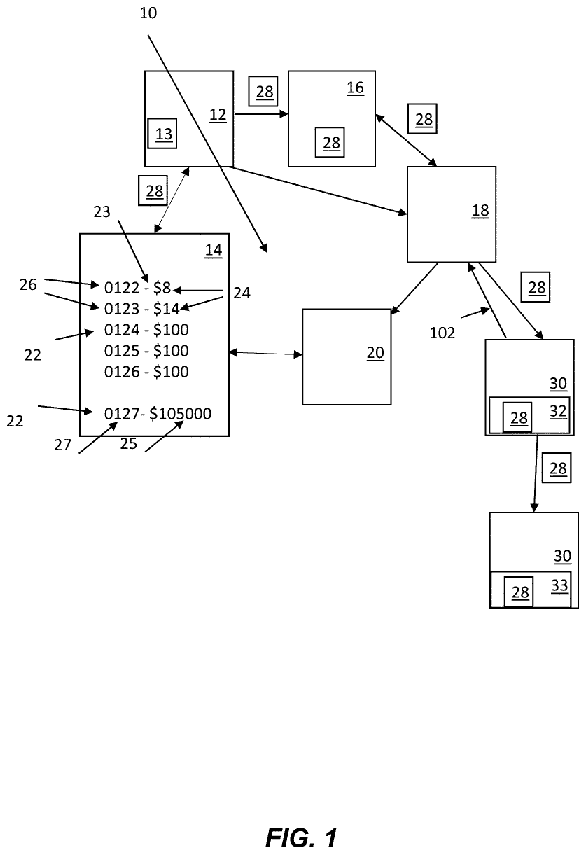

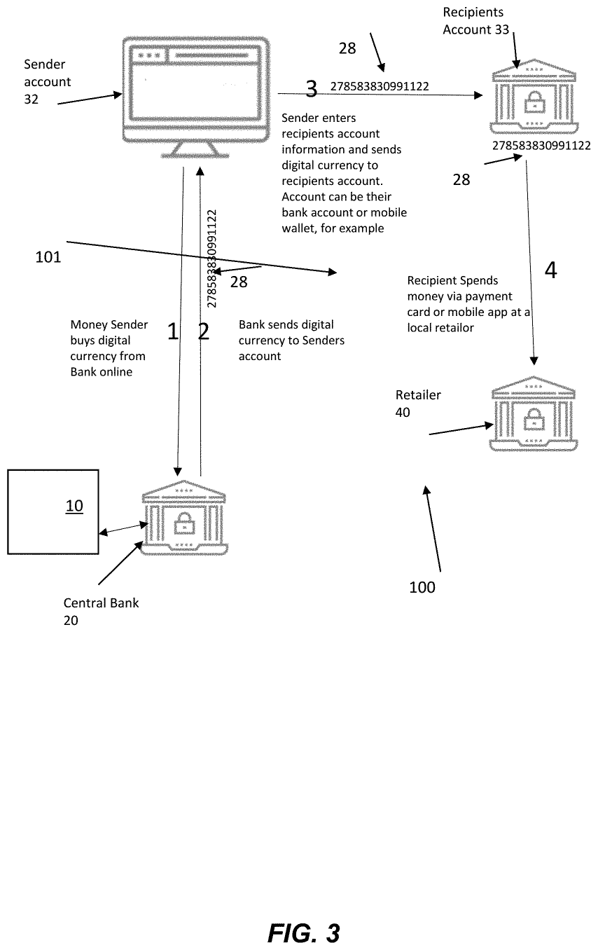

Referring to FIG. 1, shown is a digital currency generation system 10 having a cryptographic processor 12, a list of serial numbered units of currency 14 (containing a plurality of line items 22 with respectively assigned unique serial numbers 26—see further below), a repository/storage 16 of the generated digital currency 28 (e.g. represented as a series of encrypted digital values associated with the unique serial numbers 26), and a currency distributor 18 (i.e. a system used to release the generated digital currency 28 into general money circulation as further described below). The list 14 can be generated by a centralized financial institution 20, such as a national mint of a country or other designated entity used to generate new currency (i.e. not in previous circulation in an established financial system—e.g. banking system) for a particular country, also referred to as a central bank of the specified country (for example the U.S. Department of the National Treasury for the United States of America). For example, the centralized financial institution 20 can operate the system 10 (e.g. the components 12, 14, 16, 18) and/or can outsource one or more of the components 12,14,16,18 to a third party system. As such, it is envisioned that all of the components 12,14,16,18 and bank 20 are coupled to one another via a communications network 101 (see FIG. 3).

For example, the list 14 can contain the unique serial numbers 26 (e.g. numerical, alphanumeric, or any other sequence of characters useful in representing a plurality of individual unique serial IDs), such that each unique serial number is associated 23 with a corresponding specified denomination 24 of currency (e.g. $8, $100, etc.). As such, it is recognised that each unit denomination of digital currency can be assigned 23 a corresponding unique serial number 26, as provided in the list 14. It is recognised that the denominations 24 can be predefined denominations (e.g. $1, $5, $10, $20, $50, $100, etc.) similar to today's denominations minted/printed by central banks.

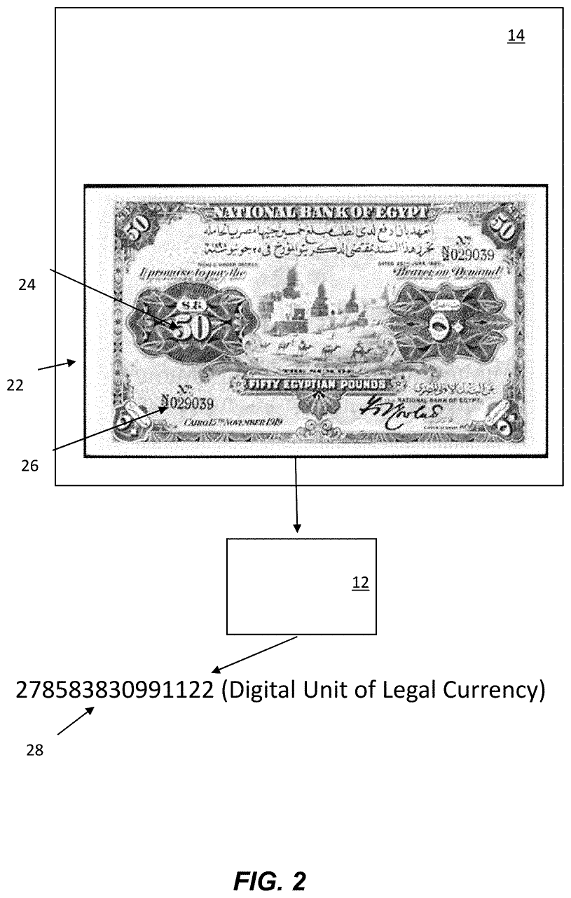

As such, prior to the initiation of a financial transaction 100 (see for example FIG. 3) by an account holder 32,33, the cryptographic processor 12 processes each list item 22 (see FIG. 2) in order to generate the corresponding encrypted digital unit(s) of currency 28, for example on demand, as needed in order to complete the financial transaction 100 (e.g. provided as a good and/or service for a specified monetary amount equal to the generated digital unit(s) of currency 28). These encrypted digital units of currency 28 can then be stored in the repository 16 until eventually distributed by the currency distributor 18 (e.g. sent to a financial institution 30 which then releases the encrypted digital units of currency 28 into bank/financial accounts 32,33 of individuals), which then can be used in subsequent transactions 100 as desired. Accordingly, serial numbers 26,27 can also be referred to as serial IDs.

Alternatively, the encrypted digital units of currency 28 can be generated dynamically in response to a denomination request 102 received by the currency distributor 18, for example as not immediately associated with a particular financial transaction 100. For example, the financial transaction 100 (e.g. payment of an invoice) could involve a custom denomination 25 (e.g. $105000) to be transferred between a payor account 32 and a payee account 33. In this case, as part of the injection of new currency into general circulation, the financial institution 30 can request 102 the generation of a customized denomination 25 (e.g. $105000) to the currency distributor 18, which would then request the centralized financial institution 20 to generate a corresponding serial number 27 for the customized denomination 25 as an added custom line item 22 in the list 14. It is recognised that the list can be used as record in order to explicitly associate the respective serial number 26 associated 23 with the corresponding digital unit/denomination of currency 24.

Given the above, it is recognised that the encrypted digital units of currency 28 can be referred to as digital fiat currency. Importantly, it is recognised that the encrypted digital units of currency 28 are not represented as cryptocurrency as they do not use a distributed ledger based processing system in their generation. Rather, the system 10 is provided advantageously as a system that “mints” serial numbered units of digital currency 28 that can be transferred between any two entities 32, 33 (or several sequential entities) to facilitate the financial transaction 100. The ownership of the encrypted digital units of currency 28 actually changes hands in each transaction 100 the same way physical money does, i.e. is transferred from one financial institution account 32 to another financial institution account 33. It is recognised that the accounts 32, 33 could be ewallets associated with different individuals, for example stored on a digital device such as a smartphone, as desired.

This transfer allows the encrypted digital units of currency 28 to be tracked as they change hands, by the corresponding serial number 26,27 that each denomination 24,25 contains, rather than relying upon a distributed ledger based system (e.g. blockchain). Further, it is recognised that each entity account 32, 33 is known and has at some point provided information to satisfy financial regulatory requirements. In other words, each of the entity accounts can be registered in a financial system and thus associate with a particular legal entity (e.g. individual, company, etc.).

One advantage of the encrypted digital units of currency 28 and associated transactions 100 is that artificial intelligence in the system 10 (or third party artificial intelligence) can analyze transaction 100 patterns to discern patterns of money laundering, terrorist financing, tax evasion and/or any other criminal behavior, as each of the denominations 24,25 is identifiable via the associated serial number 26,27. Further, the serial numbered 26, 27 nature of the encrypted digital units of currency 28 make them identifiable in cases of theft/hacking and can be removed from circulation not unlike a stolen credit card. New encrypted digital units of currency 28 can be issued to replace stolen/hacked currency 28.

Referring again to FIG. 1, the list 14 can be referred to as a centralized ledger 14 (or general ledger 14), therefore not a distributed ledger, as the list 14 contains all denominations 24,25 and their associated 23/assigned serial numbers 26,27 as the line items 22 in the central ledger 14. It is recognised that the serial numbers 24,25 are also encrypted and therefore included as part of the encrypted digital units of currency 28, as processed by the cryptographic processor 12. A representative example of the generation of the encrypted digital units of currency 28 by the cryptographic processor 12 is shown in FIG. 2 (i.e. the $50 denomination 24 with the serial number 26 as an individual line item 22 in the list 14). Further, the encrypted value 278583830991122 represents the encrypted digital unit of currency 28, such that decryption of the value 278583830991122 would allow the identification of the encrypted digital unit of currency 28 to contain the denomination 24 of $50 and the serial number 26 of 209039, by example.

Cryptography of the cryptographic processor 12 is used to inhibit counterfeiting of the currency 28. Further, more traditional systems such as block chain (utilizing a distributed ledger system) and/or other storage mediums can be used to record the history of ownership (e.g. via transactions 100) of every individual encrypted digital unit of currency 28. However, it is recognised that the list 14 is embodied as a centralized ledger (or plurality of centralized ledgers 14) used to record the associations 23 between the unique serial numbers 26, 27 and the corresponding denominations 24, 25 (i.e. via the plurality of individual line items 22 in the centralized ledger(s) 14).

### Cryptographic Processor 12

It is recognised that the cryptographic processor 12 can use any algorithm 13 desired, such as a specified function (e.g. hash) in combination with (or as an alternative to) a selected cryptographic key scheme (e.g. private/public key cryptography), in order to generate the encrypted digital units of currency 28.

For example, a function of the algorithm 13 (e.g. including a function) can take an input (i.e. including the denomination 24,25 and the associated 23 serial number 26,27) and produce an output (i.e. the encrypted digital unit of currency 28). An input can generally be part of a whole. For example, the part can be a few numbers, whereas the whole in this case would be the entire integer set. The whole is also called the “domain”. Some common examples of domains are: integers, UTF-8 character set, all prime numbers. For example, if you feed N inputs to a function and if it produces N outputs, then the function is called a map function. Example: square(1, 2, 3, 4)=(1, 4, 9, 16). If you feed N inputs to a function and if it produces exactly 1 output, then the function is called a reduce function. Example: sum(1, 2, 3, 4)=10. In terms of hashing, hashing can be referred to as basically the act of using a hash function in order to produce a hash output. Examples of popular hash functions are SHA256, MD5, Bcyrpt, RIPEMD. A hash function takes an input of any size (e.g. the individual line item 22 contents). The output of a hash function is of fixed size (say, a 64-character text). The output is also called a digest used to represent the encrypted digital unit of currency 28. In hashing, given an input, it is easy to compute the output. But it is practically impossible to reverse engineer a hash output and derive the input. Hence a hash function can also be called a one-way function. It is recognised that in general, one may not use hashing for encryption and decryption (as decryption could be impossible due to the one-way nature). Technically, encryption/decryption functions are map functions (N to N). A hash function can be referred to as a reduce function (N to 1). So fundamentally, cryptography and hashing can be different methods, though they may be combined for certain applications (such as public key cryptography). A hash output can be useful to represent an input. This representation is called a fingerprint. This is useful if you want to make sure your data is not tampered or corrupted when it travels in a network. The hash of “sent data” should always equal the hash of “received data”. Basically, comparison of data is the most common use of hashing. In this way, for example, the receiver of the encrypted digital units of currency 28 would be able to use the same hash function (used in its generation of the encrypted digital units of currency 28), in order to ascertain the validity of the encrypted digital units of currency 28.

In terms of Public Key Cryptography, a network transaction 100 involves: a sender, the network pipe and a receiver. A network transaction 100 happens when a unit of data (encrypted digital units of currency 28) is moved at a particular point of time. Securing contents of a transaction 100 is of importance. By securing, we mean that confidentiality and tamper-proofing is taken care of. Public key cryptography solves the problem of signing, confidentiality and tamper-proofing of the contents (e.g. encrypted digital units of currency 28) of the network transactions 100. Confidentiality is achieved by garbling (mixing up) the data in motion. A key is a number or a function that can be used to garble a piece of data (e.g. encrypted digital units of currency 28). This is called encryption. A key can be used to reconstruct the original data (e.g. the denomination 24, 25 and/or the serial number 26,27) from the garbled data. This is called decryption. If you use the same key for both encryption and decryption, then it is called symmetric cryptography. These key is private and is held only by the sender and the receiver. Asymmetric cryptography can be used to facilitate key-sharing for the cryptography algorithm 13. Here, one would use one key for encryption and a different key for decryption. In public key cryptography, there are typically 5 elements: the actual data (e.g. encrypted digital units of currency 28), sender's public key, sender's private key, receiver's public key and receiver's private key. A public key is announced and known to the world. A private key is stored in the owner's mind or in a physical/digital safety locker. Private key is otherwise called a secret key. At a given point, a sender can make use of 3 keys: sender's private key, sender's public key and the receiver's public key. Similarly, a receiver can make use of receiver's private key, receiver's public key, and the sender's public key. Needless to say, one party can never know another party's private key. The combination of public & private keys is called a key-pair. This pair can be generated by a computer. It does not matter the order in which you use the keys. You can encrypt a piece of data with a public key, but the decryption can be done only with its corresponding private key. The reverse is also true. You can encrypt data with your private key. But it can be decrypted only with your public key. A sender (e.g. the cryptographic processor 12) could always start with the receiver's public key for encryption. The receiver (e.g. the account 32, 33 holder) would use its own (receiver) private key for decryption. This fulfills the goal of confidentiality (data scrambling & reconstruction). So confidentiality is achieved by using the receiver's key-pair. Additionally, the transaction 100 could utilize signing, as the receiver may not know who sent the data. It could have been sent by a hacker. So the sender could let the receiver know that the data is indeed sent by the sender. This process is called signing.

Signing can be done by attaching a small piece of additional data to the encrypted digital units of currency 28) called the signature. For example, it is recognised that a signature can be created by using the sender's key-pair. In this process, the sender first encrypts the data with sender's private key. Lets call the result sender-privkey-encrypted-data (this is the signature). Now sender combines the signature and the data. Let's call this “data+sender-privkey-encrypted-data”. The sender will again encrypt the “data+sender-privkey-encrypted-data” with the receiver's public key. Lets call this result receiver-pubkey-encrypted-data. This “wrapped and encrypted” data is sent over the network (note that message in transit is twice the intended size, and this problem is “fixed” later). No intruder can decipher this message as only the receiver's private key can decrypt receiver-pubkey-encrypted-data. The receiver would now take the receiver-pubkey-encrypted-data and decrypt it (for the first time) with the receiver's private key. The result would be “data+sender-privkey-encrypted-data”. Receiver alone can see the “data”, hence confidentiality is achieved. The receiver would now decrypt (for the second time) only the “sender-key-encrypted-data” using the sender's public key. Let's call this “data2”. If the “data2” matches with “data”, then receiver is sure that the message was indeed sent by the sender (because only sender's private key could have encrypted “data” to create “data2”). Data matching can also facilitate that message of the transaction 100 is not corrupted. Overall, a double-encryption process can be used in order to send the encrypted digital units of currency 28 via the transaction 100 (or to otherwise transfer the encrypted digital units of currency 28 from the currency distributor 18 to the financial institution 30). The sender needs to sign (with sender's private key) and sender needs to encrypt (with receiver's public key). Note that the message in transit can be twice the size of the intended message. This is because of the signature “sender-privkey-encrypted-data”. The size of the signature can be compressed by hashing the actual data and then encrypting only the hash. Hence, instead of encrypting a huge “data+sender-privkey-encrypted-data”, we can encrypt only the “data+sender-privkey-encrypted-hash”.

Advantages of the system 10 include that a government implementing the technology can facilitate the country's national mint 20 to issue their national currency in a digital format, i.e. the encrypted digital units of currency 28. Accordingly, the system 10 uses the serial numbers 24,25 and uses cryptography (the algorithm 13 via the cryptographic processor 12) to generate units of legal digital currency 28. Unlike crypto currency, the system 10 creates actual units of trackable currency, i.e. such that each unit of digital currency 28 has a serial number 26, 27 associated 23 with the specified denomination 24, 25. Both the serial number 26, 27 and the specified denomination 24, 25 are encrypted as part of the code embodying the encrypted digital unit of currency 28. Further, unlike cryptocurrency, the encrypted digital units of currency 28 uses a centralized ledger 14 to list the unique serial numbers 26,27 of each of the plurality of denominations 24,25 itemized in the list. For example, the list 14 can contain a plurality of unique serial numbers 26 associated 23 with a same value denomination 24 (e.g. different unique serial numbers 26 for each unit of the same denomination 24 value, thus representing a plurality of a defined denomination present in the list 14). For example, the centralized institution 20 can issue a plurality of the same denominations 24 (e.g. $20), each having a different unique serial number 26.

As such, it is recognised that the system 10 can integrate into the existing currency minting processes of a country for the creation of a national currency, albeit in a digital format (e.g. encrypted digital units of currency 28). The can provide for a seamless creation of manageable, counterfeit proof, and trackable digital currency 28. Further, the ability to track digital currency 28 throughout an economy can provide a long list of benefits and can solve several serious existing threats to sovereign nations, including the ability to detect and rescind compromised currency 28 units (i.e. counterfeited), as well as to cancel or otherwise recall existing digital currency 28 which is expected to be held or otherwise used by nefarious individuals/organizations. A further advantage of the encrypted digital units of currency 28 is that the currency 28 can be transferred without requiring any of the existing banking or credit card payment rails.

Other advantages of the currency 28 can include: reducing cost of printing money, as digital money 28 doesn't require physical minting; inhibiting possible counterfeiting as cryptographic public and private keys of the cryptographic processor 12 provide encrypted security; can reduce tax evasion as all money 28 and transactions 100 are trackable to an individual person; can facilitate governments to electronically collect taxes at point of purchase; can inhibit money laundering as artificial intelligence systems can be used to scan the transactions 100 (containing an identification of the serial numbers of the currency 28 used in the transaction 100) for patterns of money movement that are indicative of money laundering; reduce costs of international money remittance and international payments as the currency 28 does not require intermediary US or foreign banks to facilitate the international movement of money; can reduce losses due to theft or hacking as hacked or stolen funds can be automatically eliminated from circulation and replaced with new funds using the recall function of the system 10; and can improve a country's debt rating by providing the country with an auditable digital payments service for both local and international transactions 100 via the currency 28 and associated serial numbering 24.

Referring to FIG. 3, shown is a transaction 100 process for the digital currency 28 using an electronic communication network 101 to distribute the digital currency 28 from the system 10 to a final destination of a retailer 40 (e.g. proving goods/services). As such, the digital currency 28 is purchased 1 or otherwise is deposited 2 into a sender's account 32, once generated by the system 10. It is recognised that the generation of the currency 28 can be asynchronous or synchronous, with respect to a request 102 by the sender. For example, in an asynchronous mode, the digital currency 28 can be generated and stored in the storage 16 (see FIG. 1) as a predefined denomination 24 ($10, $20, etc.), before the system 10 eventually distributes the currency 28 via the currency distributor 18 at a later time/date. Alternatively, the system 10 can receive a custom request 102 from the sender (see FIG. 1), which specifies the desired custom denomination 25 amount. Once requested, the system 10 can generate the currency 28 (with associated 23 serial number 27 and custom denomination 25) and then send 2 to the sender via the currency distributor 18 (see FIGS. 1, 3). It is recognised that the distributor 18 can provide 2 the generated digital currency 28 to the sender due to the custom request 102, can provide 2 the generated digital currency 28 to the sender due to a purchase request 1 (see FIG. 3) for standardized (i.e. predefined) denomination(s) 24, or can provide 2 the generated digital currency 28 to a financial institution 30 as part of the currency float distributed to financial institutions 30 overseen by the centralized bank 20.

Further, FIG. 3 shows an example distribution of the digital currency 28 to a recipient's account 33, as another example of the transaction 100. As such, the transaction 100 can represent a transfer of digital currency between sender/recipient, can represent a transfer of digital currency 28 between the system 10 and the sender's account 32, and/or can represent the purchase of goods/services using the digital currency 28.

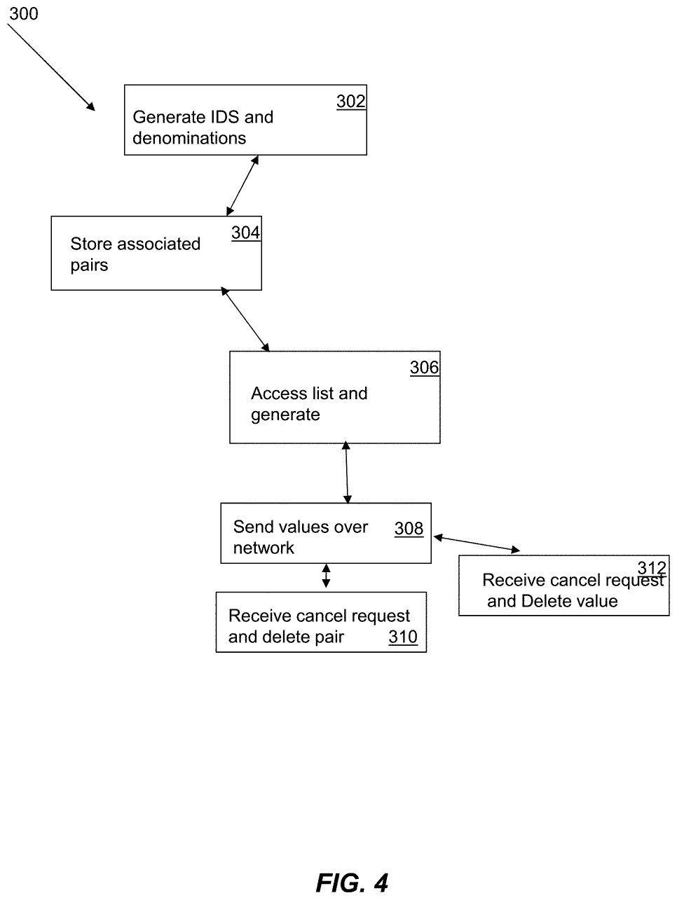

Referring to FIG. 4, shown is an example method 300 for implementing the digital currency 28. At step 302 generate a plurality of unique serial IDs 26,27 and corresponding currency denominations 24,25 for the digital currency, each of the currency denominations 24,25 associated with at least one of the plurality of unique serial IDs 26,27. At step 304 store the plurality of unique serial IDs 26, 27 and corresponding currency denominations 24,25 in a centralized list 14 as associated pairs 23 (e.g. list items 23). At step 306 access the list 14 and generate the encrypted digital values 28 using each associated pair 23 of the plurality of unique serial IDs 26, 27 and corresponding currency denominations 24, 25 for the digital currency, each of the encrypted digital values 28 representing the encrypted digital currency. At step 308 send one or more of the encrypted digital values 28 to an institution 30 over a communications network 101 for storage in a financial account 32 as an account deposit of the one or more of the encrypted digital values 28.

Other steps can include receive 310 a request to cancel a selected one of the associated pairs 23 from the list 14, in order to remove the corresponding encrypted digital value 28 as a valid form of digital currency from the encrypted digital currency list 14, i.e. by removing the selected/specified pair from the list 14 in response to the received 310 request.

Other steps can include receive 312 a request to cancel a selected encrypted digital value 28 and thereby delete the selected encrypted digital value 28 from storage in order to remove the selected encrypted digital value 28 as a valid form of digital currency from the encrypted digital currency; and regenerate a replacement encrypted digital value 28 corresponding to the selected encrypted digital value 28; wherein the replacement encrypted digital value is generated using the associated pair corresponding to the selected encrypted digital value.

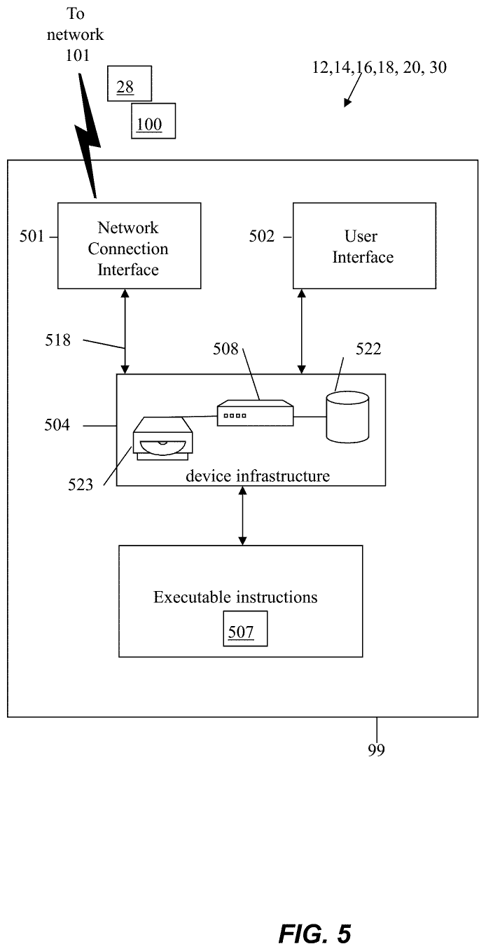

Referring to FIG. 5, shown is an example computing device for representing individually any of the components 12,14,16,18 of the system 10. Referring to FIG. 5, shown is such that operation of the device 99 (as implemented by any of the components 12, 14, 16, 18 and/or institutions 20, 30) is facilitated by the device infrastructure 504. The device infrastructure 504 includes one or more computer processors 508 and can include an associated memory 522. The computer processor 508 facilitates performance of the device 99 configured for the intended task (e.g. of the respective operation/functionality of any of the servers/components 12,14,16,18 as described) through operation of the network interface 501, the user interface 502 and other application programs/hardware of the device 99 by executing task related instructions. These task related instructions 107 can be provided by an operating system, and/or software applications located in the memory 522, and/or by operability that is configured into the electronic/digital circuitry of the processor(s) 508 designed to perform the specific task(s). Further, it is recognized that the device infrastructure 504 can include a computer readable storage medium 523 coupled to the processor 508 for providing instructions 107 to the processor 508 and/or to load/update the instructions 507. The computer readable medium 523 can include hardware and/or software such as, by way of example only, magnetic disks, magnetic tape, optically readable medium such as CD/DVD ROMS, and memory cards. In each case, the computer readable medium 523 may take the form of a small disk, floppy diskette, cassette, hard disk drive, solid-state memory card, or RAM provided in the memory module. It should be noted that the above listed example computer readable mediums 523 can be used either alone or in combination.

Further, it is recognized that the computing device 99 can include the executable applications comprising code or machine readable instructions 107 for implementing predetermined functions/operations including those of an operating system and the modules, for example. The processor 508 as used herein is a configured device and/or set of machine-readable instructions for performing operations as described by example above, including those operations as performed by any or all of the modules. As used herein, the processor 508 may comprise any one or combination of, hardware, firmware, and/or software. The processor 508 acts upon information by manipulating, analyzing, modifying, converting or transmitting information for use by an executable procedure or an information device, and/or by routing the information with respect to an output device. The processor 508 may use or comprise the capabilities of a controller or microprocessor, for example. Accordingly, any of the functionality of the modules may be implemented in hardware, software or a combination of both. Accordingly, the use of a processor 508 as a device and/or as a set of machine-readable instructions is hereafter referred to generically as a processor/module 508 for sake of simplicity.

It will be understood in view of the above that the computing devices 99 may be, although depicted as a single computer system, may be implemented as a network of computer processors, as desired.

Although the invention has been described with reference to certain specific embodiments, various modifications thereof will be apparent to those skilled in the art without departing from the scope of the invention as defined by the appended claim

1. A system for generating encrypted digital currency comprising:
a computer processor for executing a set of instructions stored on a computer readable medium to;
generate a plurality of unique serial IDs and corresponding currency denominations for the digital currency, each of the currency denominations associated with at least one of the plurality of unique serial IDs;
store the plurality of unique serial IDs and corresponding currency denominations in a centralized list;
access the list and generate the encrypted digital values using each associated pair of the plurality of unique serial IDs and corresponding currency denominations for the digital currency, each of the encrypted digital values representing the encrypted digital currency; and
send one or more of the encrypted digital values to an institution over a communications network for storage in a financial account as an account deposit of the one or more of the encrypted digital values.

2. The system of claim 1 further comprising receive a request for one or more of the encrypted values for said account deposit.

3. The system of claim 1 further comprising the currency denominations including one or more predetermined values representing a standardized sequence of currency denominations.

4. The system of claim 2, wherein the request is received after said generate.

5. The system of claim 2, wherein the request is received before said generate.

6. The system of claim 5, wherein the request includes a custom denomination amount.

7. The system of claim 6 further comprising generating a serial ID for the custom denomination amount and storing the serial ID and the custom denomination amount as associated with one another in the list.

8. The system of claim 1, wherein the list is a centralized ledger.

9. The system of claim 8, wherein the one or more of the encrypted digital values pertain to a network transaction, such that transaction information of the transaction is stored in a distributed ledger.

10. The system of claim 1 further comprising storing the encrypted digital values in a storage prior to said sending.

11. The system of claim 1 further comprising storing the encrypted digital values or a records representing the encrypted digital values in a storage prior to said sending.

12. The system of claim 11, wherein the storage is the list, such that each respective one of the encrypted digital values is associated in the list with the corresponding said each associated pair in order to correlate the each respective one of the encrypted digital values with one of said each associated pair.

13. The system of claim 1, wherein the list includes at least one of the currency denominations having a plurality of instances in the list, such that each instance is associated with a respective one of the plurality of unique serial IDs.

14. The system of claim 1 further comprising receive a request to cancel a selected one of the associated pairs from the list, in order to remove the corresponding encrypted digital value as a valid form of digital currency from the encrypted digital currency.

15. The system of claim 1 further comprising:
receive a request to cancel a selected encrypted digital value;
delete the selected encrypted digital value from storage in order to remove the selected encrypted digital value as a valid form of digital currency from the encrypted digital currency; and
regenerate a replacement encrypted digital value as replacement encrypted digital value corresponding to the selected encrypted digital value;
wherein the replacement encrypted digital value is generated using the associated pair corresponding to the selected encrypted digital value.

16. The system of claim 1, wherein the Ids are represented using alphanumeric characters.

17. A method for generating encrypted digital currency using a computer processor for executing a set of instructions stored on a computer readable medium, the method comprising;
generate a plurality of unique serial IDs and corresponding currency denominations for the digital currency, each of the currency denominations associated with at least one of the plurality of unique serial IDs;
store the plurality of unique serial IDs and corresponding currency denominations in a centralized list;
access the list and generate the encrypted digital values using each associated pair of the plurality of unique serial IDs and corresponding currency denominations for the digital currency, each of the encrypted digital values representing the encrypted digital currency; and
send one or more of the encrypted digital values to an institution over a communications network for storage in a financial account as an account deposit of the one or more of the encrypted digital values.

18. The method of claim 17 further comprising: receive a request for one or more of the encrypted values for said account deposit.

19. The method of claim 17 further comprising: receive a request to cancel a selected one of the associated pairs from the list, in order to remove the corresponding encrypted digital value as a valid form of digital currency from the encrypted digital currency.

20. The method of claim 17 further comprising:
receive a request to cancel a selected encrypted digital value;
delete the selected encrypted digital value from storage in order to remove the selected encrypted digital value as a valid form of digital currency from the encrypted digital currency; and
regenerate a replacement encrypted digital value as replacement encrypted digital value corresponding to the selected encrypted digital value;
wherein the replacement encrypted digital value is generated using the associated pair corresponding to the selected encrypted digital value.
